(19) United States
(12) Patent Application Publication
(10) Pub. No.: US 2023/0403041 A1
(43) Pub. Date: Dec. 14, 2023

(54) SELF-INTERFERENCE CANCELLATION IN RF TRANSCEIVERS

(71) Applicants: Zhihong Hunter Hong, Kanata (CA); Liang ZHANG, Ottawa (CA); Wei LI, Kanata (CA); Yiyan WU, Kanata (CA); Sébastien LAFLÈCHE, Gatineau (CA); Douglas PRENDERGAST, Ottawa (CA)

(72) Inventors: Zhihong Hunter Hong, Kanata (CA); Liang ZHANG, Ottawa (CA); Wei LI, Kanata (CA); Yiyan WU, Kanata (CA); Sébastien LAFLÈCHE, Gatineau (CA); Douglas PRENDERGAST, Ottawa (CA)

(73) Assignee: His Majesty the King in Right of Canada, as represented by the Minister of Industry, through the Co, Ontario (CA)

(21) Appl. No.: 18/128,849

(22) Filed: Mar. 30, 2023

Related U.S. Application Data
(60) Provisional application No. 63/350,619, filed on Jun. 9, 2022.

(51) Int. Cl. H04B 1/04; H04B 1/10; H04L 25/08

(52) U.S. Cl. CPC H04B 1/0483; H04B 1/1018; H04L 25/085

(57) ABSTRACT

An RF transceiver includes an RF transmitter coupled to a broadcast antenna, an RF receiver coupled to a receiving antenna, and a communication channel to provide an RF reference signal from the transmitter to the receiver to assist in canceling a transmitter-induced interference signal at the receiver. A digital processor of the receiver is configured for adaptive filtering the RF reference signal in the frequency domain to estimate the spectrum of the interference signal, and estimating a spectrum of a remotely-transmitted signal based on the estimated interference spectrum and a spectrum of a received signal from the receiving antenna. The filtering includes estimating frequency-domain filter weights based, at least, on spectra of the received and reference signals, and de-noising of the estimated filter weights. The interference cancellation may be iteratively improved using a re-modulated feedback from a demodulator and/or a decoder in the signal processing chain of the receiver.

### CROSS REFERENCE TO RELATED APPLICATIONS

This application claims priority from the U.S. Provisional Patent Application No. 63/350,619, filed on Jun. 9, 2022, entitled “Self-Interference Cancellation in RF Transceiver” which is incorporated herein by reference in their entirety.

### TECHNICAL FIELD

The present disclosure generally relates to wireless communication systems, and more particularly to wireless multicast/broadcast communication systems using a plurality of transmission towers.

### BACKGROUND

In traditional terrestrial broadcast systems, backhaul data is delivered from a broadcast gateway to broadcast transmitters via studio-to-transmitter links (STL). The STL links are usually implemented using wired connections or dedicated microwave links, both suffering from issues with availability and cost. For the legacy high-power-high-tower (HPHT) deployments, where a single tower covers an entire city, these solutions are affordable.

However, new generation terrestrial broadcasting systems, such as the Advanced Television Systems Committee (ATSC) 3.0, single-frequency-network (SFN) with multiple lower-power transmitters become more attractive in comparison to the traditional single-transmitter HPHT system, in order to deliver mobile services to portable/handheld and indoor receivers, and to support higher service quality. With the number of transmitters increasing, the existing STL solutions quickly become unaffordable. To address this challenge, a one-way wireless in-band backhaul technology to feed broadcast SFN transmitters has been described in U.S. Pat. No. 10,771,208, which is incorporated herein by reference for all purposes.

US Patent Publication 2022/0159650, which is incorporated herein in its entirety, discloses a broadcast communication system including a plurality of transmitter tower stations (TTS) configured to exchange inter-tower communication (ITC) signals to support a wireless ITC network (ITCN). Several ITCN-integrating broadcast systems operating in the same or different frequency band may be interconnected to support an integrated inter-tower wireless communication network. Each TTS includes a transmitter (Tx) antenna, at least one receiver (Rx) antenna, and an ITCN server configured to form outgoing ITC signals for transmitting with the Tx antenna and to process incoming ITC signals received with at least one Rx antenna. Each of the TTSs is configured to multiplex outgoing ITC signals with broadcast services signals prior to the transmitting and to detect the incoming ITC signals in a wireless signal received with at least one Rx antenna.

### BRIEF DESCRIPTION OF THE DRAWINGS

Embodiments disclosed herein will be described in greater detail with reference to the accompanying drawings, which are not to scale, in which like elements are indicated with like reference numerals, and wherein:

FIG. 1 is a schematic diagram illustrating a terrestrial broadcast system configured for inter-tower communications (ITC);

FIG. 2 is a schematic block diagram of an RF broadcast transceiver configured for transmitting and receiving ITC signals;

FIG. 3 is a functional block diagram of a self-interference (SI) estimation module for an RF broadcast transceiver;

FIG. 4 is a schematic block diagram of an RF broadcast transceiver including a receiver having an RF SIC module;

FIG. 5 is a schematic block diagram of an RF SI cancellation (SIC) module according to an embodiment;

FIG. 6 is a schematic block diagram of a time-domain windowing module for frequency-domain SI estimation;

FIG. 7A is a graph illustrating low-pass time-domain filtering of frequency-domain filter weights for the SI signal estimation;

FIG. 7B is a graph illustrating multi-region time-domain filtering of frequency-domain filter weights for the SI signal estimation;

FIG. 8 is a schematic circuit diagram of an RF SIC module with adaptive filter weight updates;

FIG. 9 is a schematic block diagram of an Rx processor configured for iterative RF SIC according to one embodiment;

FIG. 10 is a schematic block diagram of an Rx processor configured for iterative RF SIC according to another embodiment;

FIG. 11 is a schematic block diagram of an RF SIC module of a MIMO receiver according to an embodiment.

### DESCRIPTION

The following acronyms may be used herein:
ADC Analog-to-Digital Converter
AI Artificial Intelligence
ATSC Advanced Television Systems Committee
AWE Adaptive Weight Estimator
BCS Broadcast Communication System
CES Channel Estimation and Synchronization
DAC Digital-to-Analog Converter
DFT Discrete Fourier Transform
dNF de-Noising Filter
DPE Delay Profile Estimation
D-RFRS Direct RF Reference Signal
FDF Frequency Domain Filter
FDM Frequency Division Multiplexing
FFT Fast Fourier Transform
FWE Filter Weight Estimator
IDFT Inverse Discrete Fourier Transform
IFFT Inverse Fast Fourier Transform
IDL In-Band Distribution Link
ITC Inter-Tower Communication
ITCN Inter-Tower Communication Network
LDM Layered Division Multiplexing
MIMO Multi-Input Multi-Output
OFDM Orthogonal Frequency Division Multiplexing
OTA-RFRS Over-the-Air RF Reference Signal
RF Radio Frequency
RFRS RF Reference Signal
RFSIC RF Self-Interference Cancellation
SFN Single Frequency Networks
SI Self Interference
SIC Self Interference Cancellation
TD Time Domain
TDM Time Division Multiplexing
TDW Time Domain Windowing
TTS Transmitter Tower Station

Embodiments described herein relate to terrestrial single-frequency broadcast systems that include a plurality of broadcast stations equipped with wireless receivers to support station to station communications using in-band signaling. The broadcast stations are typically provided on transmission towers and are therefore referred to herein as transmitter tower stations (TTSs). However, the term “TTS” as used herein encompasses broadcast stations with broadcast antennas located at dedicated transmission towers as well as other suitably tall structures, e.g., on the roofs of high-rise buildings in a city environment. Some of the examples described herein may refer to ATSC 3.0 standards to deliver broadcast TV services; however, embodiments described herein are not limited to ATSC 3.0 compliant systems, but generally relate to wireless RF transceivers configured for in-band reception of wireless RF signals, such as e.g. inter-tower communication (ITC) signals. The embodiments further relate to techniques for at least partially overcoming detrimental effects of self-interference in such transceivers on reception quality using frequency-domain filtering guided by transmitter-provided reference signals, and time-domain windowing of filter weights adapted to a delay profile of the self-interference channel. Some of the embodiments may use an iterative process to update the filter coefficients based on a received signal estimate obtained by re-encoding and/or re-modulating an output signal of a decoder and/or a demodulator of a signal processing chain of the receiver.

An aspect of the present disclosure provides an apparatus comprising: a digital processor for a wireless transceiver comprising a transmitter and a receiver. The digital processor is configured for filtering a frequency-domain spectrum R(k) of a transmitter-provided reference signal R(t) to estimate an interference spectrum S_{I}(k), and estimating a spectrum E(k) of a remotely-transmitted signal at the receiver based on the estimated interference spectrum S_{I}(k) and a spectrum Y(k) of a received signal Y(t), wherein in operation the received signal Y(t) is received by the receiver from a receiver antenna. The filtering comprises estimating filter weights W(k) based, at least, on the frequency-domain spectra R(k) and Y(k), and applying a de-noising filter to the estimated filter weights.

In some implementations, the processor may be configured to divide the spectrum Y(k) of the received signal Y(t) by the spectrum R(k) of the reference signal to estimate the filter weights W(k). In some implementations, the processor may be configured to subtract, from the received signal, an estimate of a contribution therein of the remotely-transmitted signal prior to the dividing to estimate the filter weights W(k).

In any of the above implementations, the processor may be configured to subtract the estimated interference spectrum S_{I}(k) from the spectrum Y(k) of the received signal Y(t) to estimate the spectrum E(k) of the remotely-transmitted signal.

In any of the above implementations, the processor may be further configured to: a) estimate a transmission channel response for the remotely-transmitted signal based on the estimated spectrum E(k), and b) compute an estimate of the remotely-transmitted signal based on the transmission channel response. In some implementations, the processor may be further configured to: c) estimate a contribution of the remotely transmitted signal into the received signal based on the estimated transmission channel response and the estimate of the remotely-transmitted signal; d) subtract the estimated contribution of the remotely transmitted signal from the received signal to update the filter weights W(k); and, e) modify the estimated interference spectrum S_{I}(k) based on the updated filter weights to update the estimates of the transmission channel response and the remotely transmitted signal. In some implementations, the apparatus may be further configured to iteratively repeat the operations (a) to (e) until a stopping criterion is reached.

In any of the above implementations, applying the de-noising filter may comprise applying one or more time-domain windows to a time-domain representation of the filter weights. In some of such implementations, the one or more time-domain windows may comprise a low-pass window. In some of such implementations, the one or more time-domain windows may comprise a plurality of non-overlapping time-domain windows. In some implementations, the one or more time-domain windows may be selected based on an estimate of a time-delay profile of an interference channel from the transmitter to the receiver. In some implementations, the time-domain windowing may comprise DFT and inverse-DFT processing. In some implementations, the de-noising filter may comprise a Wiener filter.

In any of the above implementations, the processor may be configured to update a current set of the filter weights W(k) based on one or more earlier-generated sets of the filter weights.

In any of the above implementations the apparatus may comprise a communication channel from the transmitter to the receiver for providing the reference signal. In some of such implementations the communication channel comprises a wired connection from an output of the transmitter to an input of the receiver. In some of such implementations the communication channel may comprise an additional receiving antenna. The apparatus may comprise a broadcast antenna configured to transmit signals generated by the transmitter, and the additional receiving antenna may be a directional receiving antenna aimed at the broadcast antenna.

A related aspect of the present disclosure provides a transceiver for a wireless broadcast station, the transceiver comprising: a transmitter for connecting to a transmitting antenna to broadcast a signal; and, a receiver for connecting to a receiving antenna to receive a remotely-transmitted signal. The receiver comprises a digital processor for cancelling an interference signal from the transmitter. The processor is configured to perform the acts of: filtering a frequency-domain spectrum R(k) of a transmitter-provided reference signal R(t) to estimate an interference spectrum S_{I}(k); and subtracting the estimated interference spectrum S_{I}(k) from a spectrum Y(k) of a received signal Y(t) to estimate a spectrum E(k) of the remotely-transmitted signal, the received signal Y(t) being received from the receiving antenna. The filtering comprises: estimating filter weights W(k) based, at least, on the frequency-domain spectra R(k) and Y(k), and applying a de-noising filter to estimated filter weights.

A related aspect of the present disclosure provides a method for receiving remotely-transmitted signals by a transceiver of a wireless broadcast station, the transceiver comprising a transmitter connected to a transmit antenna and a receiver connected to a receive antenna. The method comprises filtering a frequency-domain spectrum R(k) of a transmitter-provided reference signal R(t) to estimate an interference spectrum S_{I}(k) at the receiver, and subtracting the estimated interference spectrum S_{I}(k) from a spectrum Y(k) of a received signal Y(t) to estimate a spectrum E(k) of the remotely-transmitted signal, the received signal being provided from the receive antenna. The filtering comprises: estimating filter weights W(k) based, at least, on the frequency-domain spectrum R(k) and the spectrum Y(k) of the received signal Y(t), and time-domain windowing of the filter weights.

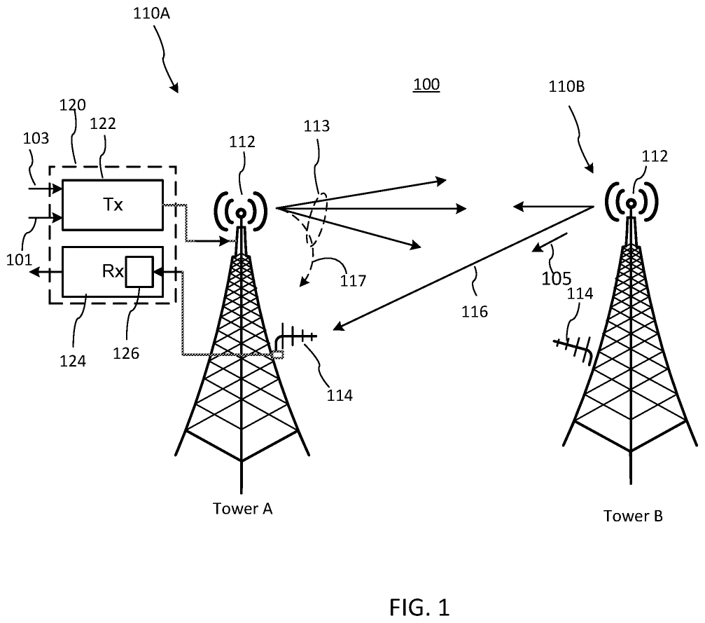

FIG. 1 illustrates a broadcast communication system (BCS) 100 in which embodiments of the present disclosure may be practiced. The BCS 100 includes a plurality of transmitter tower stations (TTS) 110, represented in FIG. 1 with a first TTS 110A and a second TTS 110B. The first TTS 110A includes an RF transceiver 120 comprising a transmitter 122 and a receiver 124, a transmitter (Tx) antenna 112 connected to the transmitter 122, and a receiver (Rx) antenna 114 connected to the receiver 124. The Tx antenna 112, which may also be referred to herein as the broadcast antenna or the first antenna, is typically (but not necessarily) an omnidirectional antenna mounted close to a top of a transmission tower (“tower A”), for transmitting at least a broadcast signal 101 to a plurality of customer receivers (not shown) that may be located at different directions from the Tower A. In addition to the broadcast signal 101, the wireless signals 113 transmitted by the Tx antenna 112 may also include an ITC signal 103 directed to another TTS, e.g. the second TTS 110B. The ITC signal 103 transmitted by the TTS 110A may also be referred to as the first ITC signal 103. In some embodiments, one or more additional Tx antennas (not shown) may be provided, e.g. for transmitting the broadcast signal 101 and/or the ITC signal 103 using a multi-input, multi-output (MIMO) communication format.

The TTS 110A is further provided with a transceiver 120 including a transmitter 122 and a receiver 124. The transmitter 122 is coupled to the Tx antenna 112 for transmitting at least the broadcast signal 101 provided by the transmitter 122. In some embodiments, the Tx antenna 112 may also transmit the ITC signals 103 sharing a same frequency band with the broadcast signal 101, e.g. for spectral efficiency (“in-band transmission”). In various embodiments, the transmitter 122 may be configured to combine the broadcast signal 101 and the ITC signal 103 using a time-division multiplexing (TDM), layer-division multiplexing (LDM), or some combination thereof, and to provide the multiplexed signal to the Tx antenna 112.

The receiver 124 is coupled to the Rx antenna 114 to receive wireless signals 116 generated by a transmitter of the second TTS 110B (“remote transmitter”, not shown). The wireless signals 116 may include the broadcast signal 101 and a second ITC signal 105 directed to the first TTS 110A, and the receiver 124 includes a processor 126 configured for detecting said second ITC signal 105 to extract ITC data contained therein. The ITC signals 103 and 105 and the broadcast signal 101 may be transmitted by the first and second TTS 110A, 110B in overlapping radio-frequency (RF) bands; such “in-band” transmission of the broadcast and ITC signals, being spectrally efficient, can however make the operation of the receiver 124 vulnerable to transmitter-receiver interference (“self-interference”).

The Rx antenna 114 is typically a high-gain directional antenna aimed at a “partner” TTS, e.g. the second TTS 110B. However, the Rx antenna 114, being typically located in a vicinity of the Tx antenna 112, may capture a stray portion 117 of the wireless signals 113 transmitted by the Tx antenna 112. When overlapped in time and frequency with the wireless signals 116 from the “partner” TTS carrying the second ITC signal 105, the captured portion 117 interferes with the detection of the second ITC signal 105 in the signal received by the processor 126 from the Rx antenna 114 (“self-interference”). According to an aspect of the present disclosure, the digital processor 126 is configured to at least partially reduce, or approximately cancel, this self-interference, e.g. as described below with reference to example embodiments.

The following terms and notations may be used herein with reference to operation of a digital processor of an RF receiver (“Rx processor”), such as the digital processor 126 of the receiver 124 of the TTS 110A. The signal received by the Rx processor from the Rx antenna that is aimed at a remote TTS (e.g. Rx antenna 114 aimed at TTS 110B) will be referred to as the received signal or the antenna signal and denoted “Y”, with a time-domain representation thereof denoted as Y(t), and a frequency-domain representation denoted as Y(k). The signal generated by the transmitter of a remote TTS (“remote transmitter”), e.g. the transmitter of the second TTS 110B, will be referred to as the remotely-transmitted signal and denoted “S”, with a time-domain representations thereof denoted as S(t), and a frequency-domain representation denoted as S(k). A reference signal provided to the Rx processor from an output of the co-located transmitter, as described below, is referred to as the RF reference signal, or RFRS, and denoted R, with the time-domain and frequency-domain representations thereof denoted R(t) and R(k), respectively. Here and in the following, “t” denotes sampling time at the receiver, and k=1, . . . , N is an integer indicating a DFT or, more specifically, FFT frequency bin, with N indicating the size of the DFT or FFT operation to convert the time-domain signals Y(t), S(t), and R(t) into the frequency domain signals Y(k), S(k), and R(k), respectively. The propagation from the remote transmitter to the Rx processor, which modifies the remotely transmitted signal S, may be described as propagation via a transmission channel having a transmission channel response denoted “F”, or F(k) in the frequency domain. The transmission channel from the remote transmitter to the Rx processor may be referred to as the forward channel (“FwCh”) and the transmission channel response “F” referred to as the forward channel response. The propagation-modified version of the remotely-transmitted signal S that is contained in the received signal Y may be referred to as the received remote signal and denoted “S_{RX}”, with the frequency domain representation thereof S_{RX}(k)≅F(k)·S(k). The received signal Y further includes an interference signal from a co-located transmitter as described above (e.g. the stray signal 117, FIG. 1), which is referred to as the self-interference (SI) signal, denoted S_{I}. The transmission channel for the SI signal, i.e. from the co-located transmitter/Tx antenna to the Rx processor, may be referred to as the loop-back channel.

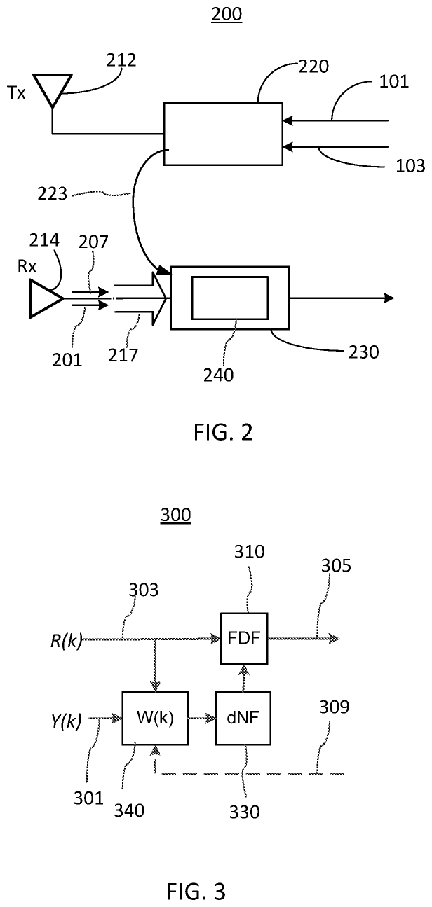

FIG. 2 illustrates an RF transceiver 200, which may be an embodiment of the transceiver 120. The RF transceiver 200 includes a transmitter 220, which may be an embodiment of the transmitter 122 of FIG. 1, and a receiver 230, which may be an embodiment of the receiver 124 of FIG. 1. The transmitter 220 is configured to generate a transmission signal for transmitting with the Tx antenna 212, which may be an embodiment of the Tx antenna 112 of FIG. 1. The transmission signal generated by the transmitter 220 may include at least one of the broadcast signal 101 and an ITC signal 103. In an example embodiment, the transmission signal generated by the transmitter 220 includes the broadcast signal 101 combined with the ITC signal 103 using LDM and/or TDM for in-band transmission of the ITC signal.

The receiver 230 is coupled to an Rx antenna 214 and includes a digital Rx processor 240. The Rx processor 240 may be an embodiment of the Rx processor 126 of FIG. 1 and is configured to process a received signal Y 217 originating from the Rx antenna 214. The Rx antenna 214 may be an embodiment of the Rx antenna 114 of FIG. 1. The received signal Y 217 may include a remote signal S_{RX} 201 and an SI signal S_{I} 207. The Rx processor 240 is configured to at least partially cancel the contribution of the SI signal 207 in the received signal Y 217 to facilitate the detection of the remotely-transmitted signal S, e.g. for de-multiplexing therefrom of an ITC signal (e.g. the ITC signal 105 transmitted by the remote TTS 110B, FIG. 1). The digital Rx processor 240 may be implemented with one or more hardware processors, which in some embodiments may be shared with the transmitter 220.

According to an aspect of the present disclosure, the digital Rx processor 240 is configured to perform the SI cancellation (SIC) based on a transmitter-provided RFRS 223, using a frequency-domain filtering of the RFRS 223 for SI estimation. The RFRS 233 is an RF signal tapped off from an output signal of the transmitter 220. In the context of this specification, “RF” refers to the broadcast frequencies of a corresponding broadcast transmitter, e.g. between 100 MHz and 10 GHz typically.

FIG. 3 illustrates a functional block diagram of an SI estimator 300, which may be implemented by the processor 240 in an example embodiment. The SI estimator 300 includes a frequency-domain filter (FDF) 310, a filter weights estimator (FWE) 340, and a de-noising filter (dNF) 330. In operation, the FWE 340 receives a spectrum Y(k) 301 of a signal Y(t) received from an Rx antenna, e.g. of the signal 217 from the Rx antenna 214 of FIG. 2, and a spectrum R(k) 303 of an RFRS R(t) from a co-located transmitter, e.g. the signal 223 from the transmitter 220 of FIG. 2 and/or the Tx antenna 212. The received signal Y(t) may include, at least, a remotely-transmitted signal S(t) and an SI signal from the co-located transmitter, e.g. the Tx antenna 212. The remotely-transmitted signal S(t) may be, e.g. a signal transmitted by another TTS and may include the broadcast signal and an ITC signal to be de-multiplexed and decoded.

The RFRS 303 is filtered in the frequency domain by a frequency-domain filter (FDF) 310 using filter weights W(k), where k=1, . . . , N denote the frequency bins of an N-point digital Fourier transform (DFT) operation, e.g. an N-point fast Fourier transform (FFT). The FDF 310 outputs an estimate of a SI spectrum 305, denoted S_{I}(k), approximately in accordance with equation (1):

S_{I}(k)=R(k)·W(k) (1)

where the frequency-domain amplitudes R(k), k=1, . . . , N, are an output of the N-point DFT operation on the time-domain RF reference signal R(t). In an example embodiment, the filter weights W(k) are estimated in RF, without the down-conversion of the signals Y(t) and R(t) to the baseband. E.g. FWE 340 may compute a set {W} of N filter weights W(k) based at least on the received signal Y(t) 301 and the RFRS R(t) 303. The filter weights W(k) may be computed in the frequency domain based on the spectra Y(k) and R(k) of the respective time-domain signals Y(t) and R(t), where the frequency-domain amplitudes Y(k), k=1, . . . , N, are an output of the N-point DFT operation on the time-domain received signal Y(t).

In some embodiments, the FWE 340 may generate a first estimate of the weights W(k), using element-by-element division of the received signal spectrum Y(k) by the reference signal spectrum R(k), e.g. in accordance with equation (2):

W(k)=Y(k)/R(k) (2)

The weights W(k) may then be filtered by the dNF 330 to reduce noise, e.g. to lessen a contribution into the weights W(k) of time delays outside of an estimated delay spread of the self-interference signal from the co-located transmitter. When the SI signal from the co-located transmitter is dominant in the received signal Y(t), the set {W} of the weights W(k) provided by equation (2) approximates a frequency-domain channel transmission function for the SI signal (“loop-back channel”), from the transmitter 220 to the Rx processor of the co-located receiver, e.g. processor 240 of the receiver 230. Equation (2) may provide a least-square (LS) estimate of the loop-back S_{I} channel if the contribution into the received signal Y(t) of all other signals may be approximated by Gaussian noise, including that from the remotely-transmitted signal S(t) (“intrinsic noise”). In some embodiments the FWE 340 may use, in a next iteration, a re-modulated feedback signal 309 from a downstream demodulator or decoder (not shown) to reduce the “intrinsic noise” in the weight estimates, as further described below.

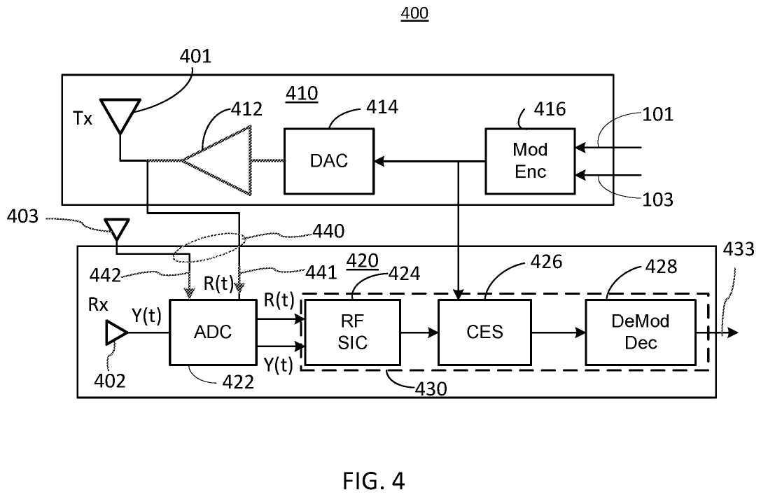

FIG. 4 illustrates an RF transceiver 400, which may be an embodiment of the RF transceiver 200. The RF transceiver 400 includes a transmitter 410 having an output power amplifier 412 coupled to a Tx antenna 401, a receiver 420 coupled to an Rx antenna 402, and an RF communication channel(s) 440 therebetween for providing the RFRS R(t) from the transmitter 410 to the receiver 420 as an analog RF signal. Two types of an RF communication channel between the transmitter 410 and the receiver are shown in FIG. 4 for illustration: a wired, or “direct”, and a wireless. A direct RFRS (D-RFRS) 441 may be provided over a wired link from an output of the transmitter 410, e.g. from a waveguide (not shown) of the Tx antenna 401 or an output of the power amplifier 412 of the transmitter 410. An over-the-air RFRS (OTA-RFRS) 442 may be provided from the Tx antenna 401 using an optional second Rx antenna 403 coupled to the receiver 420. The second Rx antenna 403 may be a directional receiving antenna aimed at the Tx antenna 401 of the co-located transmitter. A typical implementation may include one of these two communication links, and either one of the D-RFRS 441 and the OTA-RFRS 442 may embody the reference signal R(t) 303 described above with reference to FIG. 3, or any of the RFRS described below.

The transmitter 410 includes a modulator/encoder unit 416, followed by a digital to analog converter (DAC) 414. In an embodiment, the modulator/encoder 416 may be configured to encode the broadcast signal 101 and the ITC signal 103, e.g. using any suitable encoding techniques known in the art, multiplex the encoded broadcast and ITC signals using, e.g. TDM and/or LDM, and then modulate the combined signal onto a carrier or a plurality of carriers using a suitable modulation format, e.g. an orthogonal frequency domain multiplexing (OFDM). The modulator/encoder 416 may also perform other functions, such as e.g. time and frequency domain interleaving, adding of one or more pilot signals, preambles, guard intervals, etc., as will be known to those skilled in the art. The DAC 414 is configured to convert the output of the modulator/encoder 416 to an analog RF signal, which is then suitably amplified by the power amplifier 412 for transmitting, e.g. broadcasting, with the Tx antenna 401.

The receiver 420 includes an analog-to-digital (ADC) converter 422 coupled to a digital processor 430. The digital processor 430, which may be an embodiment of the Rx processor 240 of FIG. 2, is configured to process a received signal Y(t) provided by the Rx antenna 402 using the RFRS R(t), to detect in the received signal Y(t) the remotely transmitted signal S(t), e.g. the signal 116 transmitted by the TTS 110B of FIG. 1. The ADC 422 is configured to digitize the signals Y(t) and R(t) and to provide the digitized versions of these signals to the RF SIC module 424. The processor 430 includes an RF SIC module 424, which may include an embodiment of the SI estimator 300 (FIG. 3). The RF-SIC module 424 may use either one of the D-RFRS 441 and the OTA-RFRS 442, or a combination thereof, to at least partially cancel the SI signal from the co-located transmitter 410 in the received signal Y(t). An output SI-reduced signal of the RF SIC module 424 is provided to a channel estimation and synchronization (CES) module 426, which is followed by a demodulator/decoder 428. In some embodiments, the receiver 420 may have an analog SIC circuit (not shown) upstream of the RF-SIC module 424 and the ADC 422. The RF-SIC module 424 is followed by a channel estimation and synchronization (CES) module 426, which in some embodiments may be configured to provide a further SI suppression in the baseband. The CES module 426 may use known in the art techniques to compute, based on the output signal of the RF-SIC module 424, an estimate F of the channel response function of the forward channel, with a spectrum \tilde{F}(k). The CES module 426 further performs signal equalization based on the estimated channel response F to provide, to a demodulator/decoder 428, an equalized signal \tilde{F}(k)⁻¹·E(k) as an estimate of the remotely-transmitted signal S(k). The demodulator/decoder 428 may be configured to operate generally in reverse of the modulator/encoder 416 to output a decoded signal 433. The decoded signal 433 may be an estimate of a data signal encoded in the remotely-transmitted signal S(t), or a desired component of the remotely-transmitted signal. In an embodiment, the remotely-transmitted signal may be a signal transmitted by a remote TTS, e.g. the TTS 110 B of FIG. 1, and may combine a copy of the broadcast signal 101 and an ITC signal, e.g. the second ITC signal 105, directed to the TTS housing the RF transceiver 400, e.g. the TTS 110A. The decoded signal 433 may be, e.g. an estimate of an ITC data signal carried by the ITC signal 105.

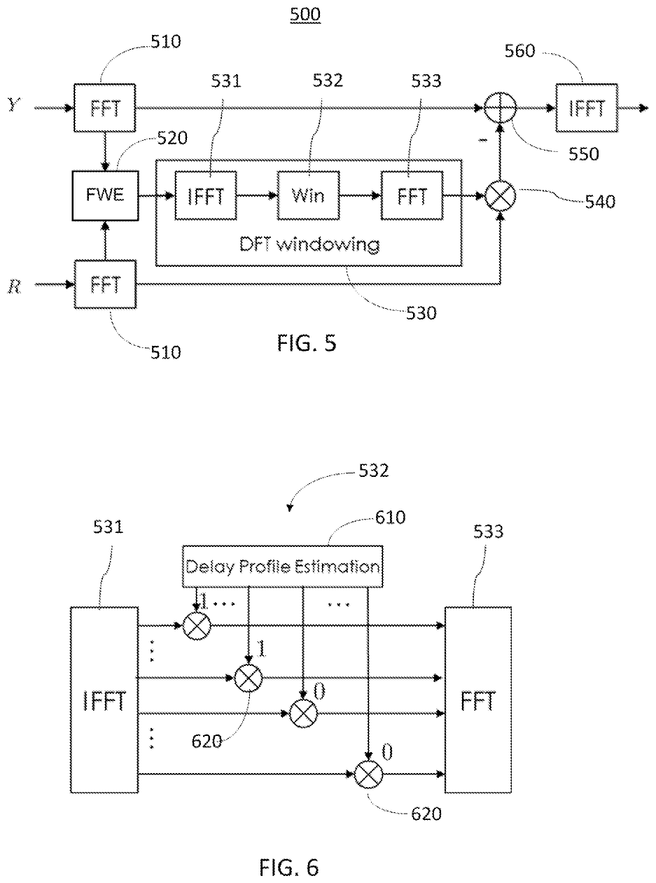

FIG. 5 illustrates a functional block diagram of a SIC module 500, which may be an embodiment of the RF-SIC module 424 of FIG. 4. In operation, the received signal Y(t) and the RFRS signal R(t) are converted to the frequency domain by FFT processors 510 using an N-point FFT operation to obtain the digital spectra Y(k) and R(k), respectively, k=1, . . . , N. The digital spectra Y(k) and R(k) are provided to a filter weight estimator (FWE) 520, which may be an embodiment of the FWE 340 of FIG. 3, to estimate a set of filter weights W(k), k=1, . . . , N. The set of filter weights W(k) is provided to a time-domain windowing (TDW) module 530, which may also be referred to as the DFT windowing module, and which is an example embodiment of the dNF 330. The TDW module 530 includes a windowing unit 532 between an inverse FFT (IFFT) unit 531 and an FFT unit 533. An output of the TDW module 530 is a modified set {Wₘ} of N frequency-domain filter weights Wₘ(k), which is applied by multipliers 540 to the RFRS spectrum R(k) to obtain an estimated SI spectrum S_{I}(k)=R(k)·Wₘ(k). The estimated SI spectrum S_{I}(k) is then used to estimate a spectrum E(k) of the received remote signal, e.g. by subtracting the S_{I}(k) from the received signal spectrum Y(k) in accordance with equation (3):

E(k)=[Y(k)−S_{I}(k)]=[Y(k)−W(k)·R(k)] (3)

FIG. 6 illustrates an example implementation of the TDW module 530 of FIG. 5. In the embodiment of FIG. 6, the TDW module 530 includes a delay profile estimation (DPE) unit 610 configured to store and/or generate an estimate of a time delay profile for the “loop-back” channel (“SI channel”), i.e. the effective transmission channel for the SI signal. In some embodiments, the DPE unit 610 may use a feedback from a baseband delay profile estimation generated by any suitable delay spread estimation algorithm. In some embodiments, the DPE unit 610 may output a digital windowing function, e.g. {V(i)=1 for i=1, . . . , I, V(i)=0 for i=I+1, . . . , N}, having a width I<N corresponding to the delay spread of the S_{I} channel, or an estimate thereof. In some embodiments, the DPE unit 610 may generate the window shape based on a time-domain profile of the filter weights W(k) estimated by the FWE unit 520.

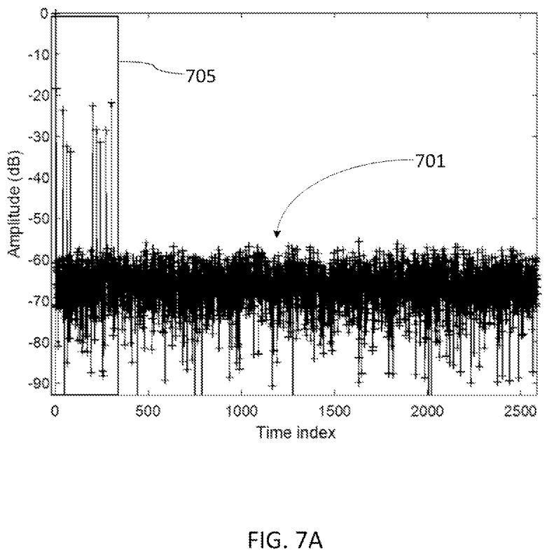

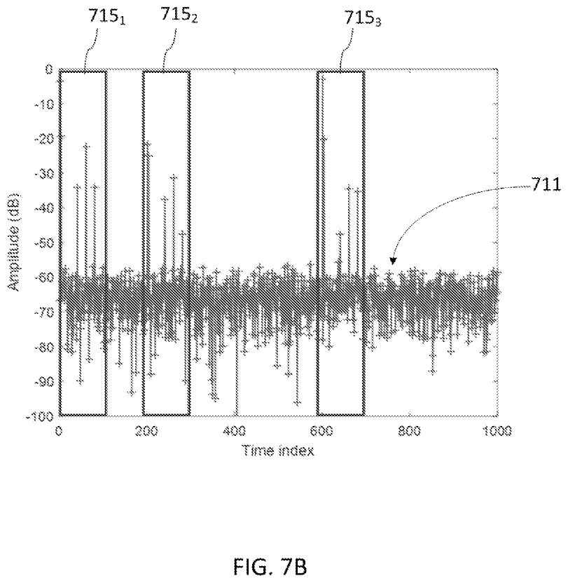

FIG. 7A illustrates an example time-domain profile 701 of the filter weights W(k), as generated by the FWE unit 520 according to a first example. The DPE unit 610 may generate a “low-pass” temporal window 705 in this example. The temporal width of the window 705 may be determined, e.g., based on a threshold for signal power loss at the output of the windowing unit 532, i.e. so that the signal at the output of the windowing unit 532 retains at least a pre-defined fraction, e.g. 85%, or 90%, or 95%, of the signal power at the input of the windowing unit 532. In the illustrated example, the temporal window V(i) 705 is a low-pass step function, with V(i)=1 for i≤I, and V(i)=0 for i>I, where I≅400, and N>2500.

FIG. 7B illustrates an example time-domain profile 711 of the filter weights W(k), as generated by the FWE unit 520, according to a second example. Such a multi-clustered time domain profile may occur, e.g. for a single-frequency network (SFN) environment where the wireless signal received by the main Rx antenna, e.g. the Rx antenna 402 of the receiver 420 (FIG. 4), may include Tx signals from a plurality of transmitters, e.g. one or more co-located wireless transmitters, e.g. the transmitter 410 of FIG. 4, and one or more remote transmitters. For this time-delay profile, the DPE unit 610 may generate and/or store a multi-cluster window 715, in the illustrated example including a low-pass window 715₁ and two band-pass windows 715₂ and 715₃, which may correspond to delay spread profiles associated with signals received from two different remote transmitters.

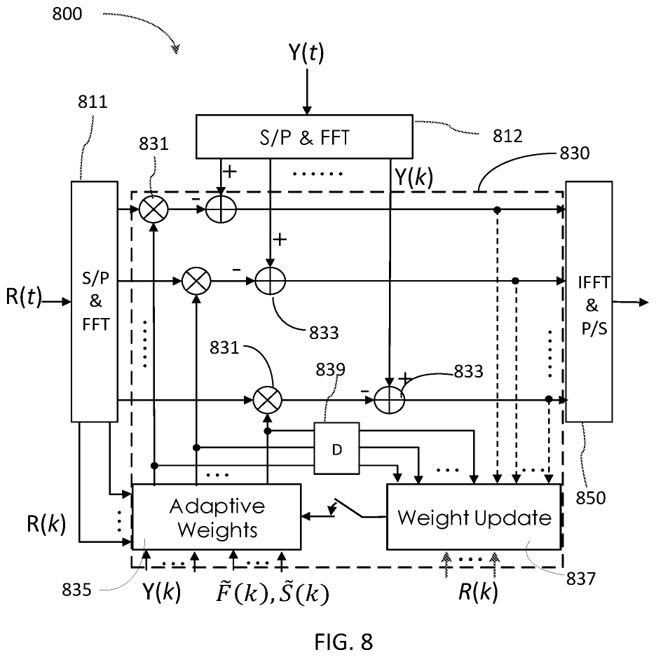

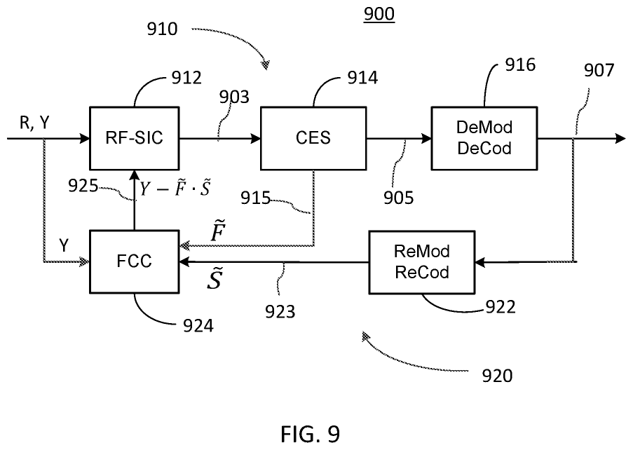

FIG. 8 illustrates an RF SIC module 800 configured to execute at least some of the RF-SIC processing described above. The RF SIC module 800 may be an embodiment of the RF SIC module 424 (FIG. 4), and may be implemented with a digital processor, e.g. the digital processor 240 of the receiver 230 of FIG. 2. The RF SIC module 800 includes a frequency-domain SIC circuit 830 connecting two N-point FFT processors 811 and 812 to a matched output IFFT processor 850. The SIC circuit 830 includes an adaptive weight estimator (AWE) 835, a weight update unit 837, a delay unit 838, a set of N digital multipliers 831, and a set of N digital subtracting circuits 833. An FFT unit 811 is configured to perform N-point FFT processing of the RFRS R(t) and to output a parallel set {R} of N spectral amplitudes R(k), k=1, . . . , N. An FFT unit 812 is configured to perform the N-point FFT processing of the received signal Y(t), e.g. the signal received from the Rx antenna 214 (FIG. 2), and to output a parallel set {Y} of N spectral amplitudes Y(k), k=1, . . . , N. The term “spectral amplitude” refers to a complex-valued phasor that accounts for both the real-valued amplitude and phase at the corresponding FFT bin. The adaptive weight estimator (AWE) 835 is configured to perform the frequency-domain filter weight estimation and the time-domain weight filtering, e.g. as described above with reference to blocks FWE 520 and DFT windowing 530 of FIG. 5. The adaptive weight estimator 835 outputs a parallel set of N filter weights W(k), which are then applied to the corresponding spectral amplitudes R(k) of the RFRS to obtain a parallel set {S_{I}} of N spectral amplitudes S_{I}(k)=R(k)·W(k), the set {S_{I}} being an estimate of the spectrum of the SI signal from a co-located transmitter, e.g. the transmitter 220 of FIG. 2. The spectral amplitudes S_{I}(k) of the estimated S_{I} spectrum are then subtracted from the corresponding spectral amplitudes Y(k) of the received signal, e.g. in accordance with equation (3), to obtain an estimate of the spectrum E(k) of a remotely-transmitted signal at the receiver.

The N-point FFT processors 811, 812 operate on blocks of consecutive time samples of the digital signals R(t) and Y(t), converting them into consecutive N-point FFT blocks {Rᵢ(k)} and {Yᵢ(k)}, with i being an integer block counter. In embodiments using OFDM, the FFT blocks {Rᵢ(k)} and {Yᵢ(k)} may be referred to as the OFDM blocks or the OFDM symbols. The AWE 835 may generate a set {Wᵢ} of N weights Wᵢ(k) for each of the FFT blocks {Rᵢ(k)} and {Yᵢ(k)}. In an embodiment, the weight update unit 837 may be configured to compute an updated set of weights Wᵤ(k) based on M>1 weight sets {Wᵢ} for M consecutive FFT blocks. The updated weight set {Wᵤ} may then be applied by the AWE unit 835 to each of the M FFT blocks {Rᵢ(k)}, or to a current FFT block {R(k)}, to compute the SI spectrum estimate S_{I}(k) and the output spectrum E(k), e.g. according to equations (1) and (3) respectively.

In some embodiments, the weight update unit 837 may be configured to use a known adaptive filtering method to update the filter weights based on the SI-reduced output spectrum E(k) and the reference signal spectrum R(k), as indicated in FIG. 8 by the dashed lines.

In some embodiments, the updated set of weight {Wᵤ(k)} may be computed by averaging the sets of weights for the M consecutive FFT blocks, e.g. using a moving average. In some embodiments the averaging may be according to equation (4a):

$${W}_{u} ( k ) = \frac{1}{M} {\sum }_{i = 1}^{M} {W}_{i} ( k ) . \qquad ( 4 a )$$

In some embodiments, the weight update may be using Wiener filtering for noise reduction, e.g. according to equation (4b):

Wᵤ(k)=Σᵢ₌₁^{M}aᵢWᵢ(k), (4b)

where {aᵢ} are coefficients of the Wiener filter.

The delay unit 839 may be a delay network configured to timely communicate the filter weight sets {Wᵢ(k)} to the weight update unit 837 according to a chosen averaging method, so that the weight update unit receives the filter weight sets of the multiple FFT blocks. In some embodiments, e.g. wherein the averaging is over (M−1) previous blocks and a current block, the averaging may be performed block by block. In some embodiment units 835, 837, and 839 may co-operate to implement a “moving average” approach wherein the updated set of weights {Wᵤ(k)} for a current FFT block is computed by averaging over a size-M window including L previous FFT blocks and L FFT blocks following the current FFT block, where L=(M−1)/2 is an integer.

In some embodiments, the SIC circuit 830 may be configured to compute the sets of filter weights W(k) iteratively, using an estimated spectrum \tilde{S}(k) of the remotely-transmitted signal and the transmission channel estimate \tilde{F}(k) as feedback at each subsequent iteration, with the \tilde{S}(k) and \tilde{F}(k) obtained from downstream signal processing in the Rx processor. The AWE unit 835 may upconvert the estimated spectrum \tilde{S}(k) and \tilde{F}(k) to the RF frequency. At a first iteration, the AWE unit 835 may compute the sets of filter weights W(k) for each FFT block based on the spectra R(k) and Y(k), e.g. as described above with reference to FIG. 3 and equation (2). In this computation, the contribution of the remotely transmitted signal S(t) in the received signal Y(t), or the spectrum thereof Y(k), is, effectively, an intrinsic noise. The SI-reduced signal spectrum E(k) computed according to equation (3) may then be optionally converted to a time-domain signal, and used to generate an estimate of the forward transmission channel response, \tilde{F}(k), and an estimate \tilde{S}(k) of the remotely-transmitted signal S(k). In a second and subsequent iterations, the AWE unit 835 may compute the filter weights W(k) for the current FFT block based on the received signal Y(k) corrected for a remote signal estimate \tilde{F}(k)·\tilde{S}(k).

$$W ( k ) = \frac{Y ( k ) - \tilde{F} ( k ) \cdot \tilde{S} ( k )}{R ( k )} \qquad ( 5 )$$

where the product \tilde{F}(k)·\tilde{S}(k) is an estimate of the remotely transmitted signal at the input to the SIC module 800. The set of weighs computed according to equation (5) is then used first to update the output spectrum estimate E(k), e.g. in accordance with equation (3), and then update the estimates \tilde{F}(k) and \tilde{S}(k) based on the updated output signal spectrum E(k). The iterations may continue, e.g., a set number of times or until a specified termination condition is met. In some embodiments, the iteratively-computed weights W(k) may then be averaged over two or more consecutive FFT blocks, e.g. as described above with reference to the weight update unit 837 and the delay unit 839.

FIG. 9 illustrates a digital processor 900, which may be an embodiment of the Rx processor 430 of FIG. 4 configured to execute an iterative RF SIC processing, e.g. as described above with reference to FIG. 8. Similarly to the Rx processor 430, the processor 900 operates on a received signal Y and an RFRS R, the received signal Y being received, via an ADC, from an Rx antenna aimed at a remote transmitter, and the RFRS R being received from the co-located transmitter via a dedicated communication channel, e.g. as described above with reference to FIG. 4. The received signal Y includes the remotely-transmitted signal S modified by the transmission from the remote transmitter (“forward transmission channel”). The received signal Y further includes an SI signal from the co-located transmitter, and possibly signals from other wireless transmitters operating in a same frequency range.

The processor 900 includes a forward signal path 910 and a feedback signal path 920. The forward signal path 910 includes a CES module 914 and a demodulator/decoder 916, which are connected in series downstream of an RF-SIC module 912. The feedback signal path 920 includes a re-encoder/re-modulator 922, and a forward signal canceller 926. The CES module 914 and the demodulator/decoder 916 may be embodiments of the CES module 426 and the demodulator/decoder 428 of FIG. 4, respectively. In operation, the CES module 914 generates an estimate F 915 of the transmission channel response for the remotely-transmitted signal S(t), with a spectrum \tilde{F}(k), based on an output signal E(k) 903 of the RF SIC module 912 and, e.g., a known pilot pattern in the S(t). The CES module 914 further processes the output signal 903 of the RF-SIC module 912 to provide an equalized signal 905 to the demodulator/decoder 916. The demodulator/decoder 916 outputs a decoded signal 907 approximating data signals carried by the remotely-transmitted signal S(t). In the feedback path 920, the decoded signal 908 is first re-encoded and re-modulated by the re-encoder/re-modulator 922 to generate an estimate S 923, or \tilde{S}(k) in the frequency domain, of the remotely-transmitted signal S(t). The re-encoder/re-modulator 922 may be configured to employ the same encoding and modulation processing as the remote transmitter, and may operate generally in reverse to the demodulator-decoder 916. The FCC module computes an estimate of the received remote signal, \tilde{F}(k)·\tilde{S}(k) and subtract this estimate from the received signal Y(t), to obtain an estimate \tilde{Y}(k) 925 of the contribution of the SI signal in the received signal, e.g. in accordance with equation (6):

\tilde{Y}(k)=Y(k)−\tilde{F}(k)·\tilde{S}(k) (6)

The estimate 925 is then provided to the RF SIC module 912 to update the filter weights W(k) e.g. according to equation (5). The updated weights are then filtered in the time domain as described above with reference to FIGS. 5-7B, and used in the next iteration to update the SI-reduced spectrum estimate E(k) 903, the forward channel estimate 915, and the decoded signal 907.

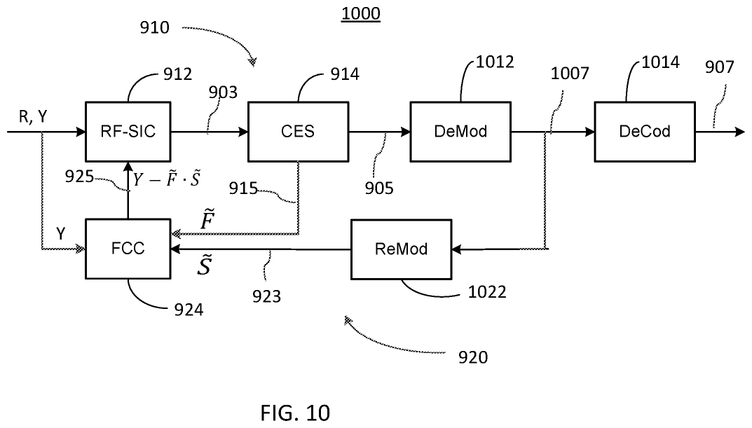

FIG. 10 illustrates an embodiment 1000 of the Rx processor 900 wherein the demodulator-decoder 916 is embodied with a demodulator 1012 and a decoder 1014, and an output signal 1007 of the demodulator 1012 is passed to a re-modulator unit 1022 to provide the feedback signal for the RF-SIC module 912.

Principles of the RF SIC described above may be extended to MIMO receivers and transmitters. The corresponding signal processing, referred to as MIMO-RFSIC, may be conveniently described in matrix form. In one embodiment, for a L×L MIMO, where L≥2 is an integer number of corresponding antennas, the reference signal and the received signal from a corresponding Rx antenna at k-th FFT bin, may be described by L×L matrices R[k] and Y[k], respectively. Weight elements may be estimated, e.g. at least in a first iteration, based on the reference and signal vectors R[k] and Y[k], and described by an L×L matrix W_{L}[k], e.g., according to equation (7):

W_{L}[k]=Y[k]·R⁻¹[k] (7)

The estimates W_{L}[k] for all k may be collected into a 3-dimensional (3D) array and processed with a DFT-windowing process for de-noising, similarly to the time-domain windowing process that is described above with reference to FIGS. 6, 7A, and 7B. At each FFT bin k, the filter weights are then multiplied by the corresponding FFT amplitudes of the reference signal, and the result is subtracted from the received signal. Optionally, the resulting signals at each FFT bin are grouped and applied with a N_{F}-point IFFT to arrive at the time-domain output signal.

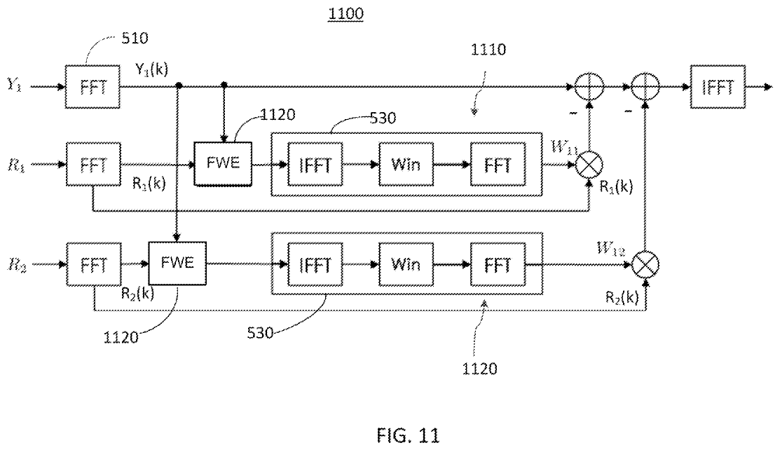

Referring to FIG. 11, in embodiments using the D-RFRS, the MIMO-RFSIC processing can be implemented in a low complexity fashion without matrix operations. FIG. 11 illustrates an example implementation of a MIMO-RFSIC module 1100 of a 2×2 MIMO receiver having an Rx antenna array with two individual Rx antennas (not shown). The received signals from the Rx antenna array are denoted as Y₁ and Y₂ (not shown), with the FFT spectra Y₁(k) and Y₂(k). Two D-RFRS, denoted R₁ and R₂, with FFT spectra R₁(k) and R₂(k), are copies of transmitter output signals fed to the two Tx antennas of the co-located MIMO transmitter (not shown). The MIMO-RFSIC module 1100 includes many of the same elements as the SIC module 500 of FIG. 5, which are indicated in FIGS. 5 and 11 with the same reference numerals. The MIMO-RFSIC module 1100 includes two instances of a FWE 1120, each followed by a corresponding instance of a TDW module 530, providing two sets of filter weighs W₁₁(k) and W₁₂(k) for applying to the first and second D-RFRS spectra R₁(k) and R₂(k).

The FWE units 1120 may be configured to iteratively compute the filter weights W₁₁(k) and W₁₂(k) as follows. The filter weights are first initialized, e.g. W₁₁⁰(k)=W₁₂⁰(k)=0. At an i-th iteration, the filter weight estimates may be updated according to equations (8A) and (8B):

Ŵ₁₁ⁱ⁺¹[k]=(Y₁[k]−W₁₂ⁱ[k]·R₂[k])/R₁[k] (8A)

Ŵ₁₂ⁱ⁺¹[k]=(Y₁[k]−W₁₁ⁱ[k]·R₁[k])/R₂[k] (8B)

A DFT windowing process may then be applied to a vector formed of Ŵ₁₁ⁱ⁺¹ [k] at all subcarriers k to obtain the refined filter weight Ŵ₁₁ⁱ⁺¹[k] for the (i+1)th iteration. Simulation results show that 3-4 iteration may be enough to obtain the filter weights with good accuracy. Outputs of the FWE units may then be subject to the DFT windowing, as described above, to obtain two sets of the filter weights W₁₁(k) and W₁₂(k). Finally, the SI-reduced output signal is then obtained as, e.g., in accordance with equation (6).

E₁[k]=Y₁[k]−W₁₁ⁱ⁺¹[k]·R₁[k]−W₁₂ⁱ⁺¹[k]·R₂[k] (9)

Example embodiments described above provide an RF transceiver (e.g. the RF transceivers 120 of FIG. 1, 200 of FIG. 2, 400 of FIG. 4) that includes an RF transmitter (e.g. 122, FIG. 1, 220 FIG. 2, 410, FIG. 4) coupled to a broadcast antenna (e.g. 112 FIG. 1, 212 FIG. 2, 401 in FIG. 4), an RF receiver (e.g. 124 in FIG. 1, 230 in FIG. 2, 420 in FIG. 4), coupled to a receiving antenna (e.g. 114 in FIG. 1, 214 in FIG. 2, 402 in FIG. 4), and a communication channel (e.g. 440 in FIG. 4) to provide an RF reference signal (E.g. 441 or 442 in FIG. 4) from the transmitter to the receiver to assist in canceling a transmitter-induced interference signal at the receiver. A digital processor (e.g. 126 in FIG. 1, 240 in FIG. 2, 430 in FIG. 4, 900 in FIG. 9, 1000 in FIG. 10), of the receiver is configured for adaptive filtering the RF reference signal in the frequency domain to estimate the spectrum of the interference signal, and estimating a spectrum of a remotely-transmitted signal based on the estimated interference spectrum and a spectrum of a received signal from the receiving antenna. The filtering includes estimating frequency-domain filter weights based, at least, on spectra of the received and reference signals, and time-domain windowing of the estimated filter weights. The interference cancellation may be iteratively improved using a re-modulated feedback from a demodulator (e.g. 1012 in FIG. 10) and/or a decoder (e.g. 428 in FIG. 4, 916 in FIG. 9, 1014 in FIG. 10) in the signal processing chain of the receiver.

Advantageously, the technique described above with reference to the example embodiments and FIGS. 2-11 allows using different, e.g. over-the-air or directly-wired, RF reference signals to perform self-interference cancellation at RF frequencies. Furthermore, the approach described above allows employing only one FFT (IFFT) block (DFT/IDFT block) in the de-noising filter (e.g. the DFT windowing module 530 in FIG. 5) to achieve near-optimal filter weights. Moreover, the DFT windowing described above can be adapted to an actual channel delay profile to potentially achieve better performance compared to a fixed window size, e.g., of half of the FFT size.

The above-described exemplary embodiments are intended to be illustrative in all respects, rather than restrictive, of the present invention. Indeed, various other embodiments and modifications to the present disclosure, in addition to those described herein, will be apparent to those of ordinary skill in the art from the foregoing description and accompanying drawings.

Furthermore, each of the example embodiments described hereinabove may include features described with reference to other embodiments. For example, the de-noising filter 330 in FIG. 3 may be configured to use Wiener filtering or an artificial intelligence (AI) based de-noising algorithm on the frequency-domain weights W(k) rather than the DFT-windowing.

Furthermore, in the description above, for purposes of explanation and not limitation, specific details are set forth such as particular architectures, interfaces, techniques, etc. in order to provide a thorough understanding of the present invention. In some instances, detailed descriptions of well-known devices, circuits, and methods are omitted so as not to obscure the description of the present invention with unnecessary detail. Thus, for example, it will be appreciated by those skilled in the art that block diagrams herein can represent conceptual views of illustrative circuitry embodying the principles of the technology. All statements herein reciting principles, aspects, and embodiments of the invention, as well as specific examples thereof, are intended to encompass both structural and functional equivalents thereof.

What is claimed is:

1. An apparatus comprising:
a digital processor for a wireless transceiver comprising a transmitter and a receiver, the digital processor configured for:
filtering a frequency-domain spectrum R(k) of a transmitter-provided reference signal to estimate an interference spectrum; and
estimating a spectrum of a remotely-transmitted signal at the receiver based on the estimated interference spectrum and a frequency-domain spectrum Y(k) of a received signal, wherein in operation the received signal is received by the receiver from a receiver antenna;
wherein the filtering comprises:
estimating filter weights W(k) based, at least, on the frequency-domain spectra R(k) and Y(k), and
applying a de-noising filter to the estimated filter weights.

2. The apparatus of claim 1 wherein the processor is configured to divide the spectrum Y(k) of the received signal by the spectrum R(k) of the reference signal to estimate the filter weights W(k).

3. The apparatus of claim 1 wherein the processor is configured to subtract the estimated interference spectrum from the spectrum Y(k) of the received signal to estimate the spectrum of the remotely-transmitted signal.

4. The apparatus of claim 1 wherein the processor is further configured to:
a) estimate a transmission channel response for the remotely-transmitted signal based on the estimated spectrum thereof,
b) compute an estimate of the remotely-transmitted signal based on the transmission channel response.

5. The apparatus of claim 4 wherein the processor is further configured to:
c) estimate a contribution of the remotely transmitted signal into the received signal based on the estimated transmission channel response and the estimate of the remotely-transmitted signal;
d) subtract the estimated contribution of the remotely transmitted signal from the received signal to update the filter weights W(k); and,
e) modify the estimated interference spectrum based on the updated filter weights to update the estimates of the transmission channel response and the remotely transmitted signal.

6. The apparatus of claim 5 further comprising iteratively repeating operations (a) to (e) until a stopping criterion is reached.

7. The apparatus of claim 1 wherein the de-noising filter is configured to apply one or more time-domain windows to a time-domain representation of the filter weights.

8. The apparatus of claim 7 wherein the one or more time-domain windows comprises a low-pass window.

9. The apparatus of claim 7 wherein the one or more time-domain windows comprise a plurality of non-overlapping time-domain windows.

10. The apparatus of claim 7 wherein the one or more time-domain windows are selected based on an estimate of a delay profile of an interference channel from the transmitter to the receiver.

11. The apparatus of claim 7 wherein the time-domain windowing unit is configured to perform DFT and inverse-DFT processing.

12. The apparatus of claim 1 wherein the de-noising filter comprises a Wiener filter.

13. The apparatus of claim 1, wherein the processor is configured to update a current set of the filter weights W(k) based on one or more earlier-generated sets of the filter weights.

14. The apparatus of claim 1 comprising a communication channel from the transmitter to the receiver for providing the reference signal.

15. The apparatus of claim 14 comprising a broadcast antenna configured to transmit signals generated by the transmitter, wherein the communication channel comprises an additional receiving antenna.

16. The apparatus of claim 15, wherein the additional receiving antenna is a directional receiving antenna aimed at the broadcast antenna.

17. The apparatus of claim 14 wherein the communication channel comprises a wired connection from an output of the transmitter to an input of the receiver.

18. A transceiver for a wireless broadcast station, the transceiver comprising:
a transmitter for connecting to a transmitting antenna to broadcast a signal; and,
a receiver for connecting to a receiving antenna to receive a remotely-transmitted signal;
wherein the receiver comprises a digital processor for cancelling an interference signal from the transmitter, the processor configured to perform the acts of:
filtering a frequency-domain spectrum R(k) of a transmitter-provided reference signal to estimate an interference spectrum; and
subtracting the estimated interference spectrum from a spectrum Y(k) of a received signal to estimate a spectrum of the remotely-transmitted signal, wherein in operation the received signal is received from the receiving antenna;
wherein the filtering comprises:
estimating filter weights W(k) based, at least, on the frequency-domain spectra R(k) and Y(k), and
applying a de-noising filter to the estimated filter weights.

19. A method for receiving remotely-transmitted signals by a transceiver of a wireless broadcast station, the transceiver comprising a transmitter connected to a transmit antenna and a receiver connected to a receive antenna, the method comprising:
filtering a frequency-domain spectrum R(k) of a transmitter-provided reference signal to estimate an interference spectrum at the receiver; and
subtracting the estimated interference spectrum from a spectrum Y(k) of a received signal to estimate a spectrum of the remotely-transmitted signal, wherein in operation the received signal is provided from the receive antenna;
wherein the filtering comprises:
estimating filter weights W(k) based, at least, on the frequency-domain spectrum R(k) and the spectrum Y(k) of the received signal, and
applying a de-noising filter to the filter weights.
